(19) United States
(12) Patent Application Publication
(10) Pub. No.: US 2003/0173384 A1
(43) Pub. Date: Sep. 18, 2003

(54) BTS: Board transportation system

(76) Inventors: Howard Charles Clark, Kailua-Kona, HI (US); Kenneth Y. Sasaki, Kailua-Kona, HI (US)

Correspondence Address: Howard C. Clark, 73-4327 Malu Place, Kailua-Kona, HI, 96740, US

(21) Appl. No.: 10/387,676

(22) Filed: Mar. 12, 2003

Related U.S. Application Data
(60) Provisional application No. 60/364,425, filed on Mar. 13, 2002.

(51) Int. Cl. B60R 9/04; B60R 9/055; B60R 7/00; B60R 11/00

(52) U.S. Cl. 224/314; 224/318; 224/328; 224/572

(57) ABSTRACT

A single unit sports board bag for storing and transporting various sports boards (e.g. surfboards, snowboards, water skis, snow skis, wakeboards, wind surfers, and kite surfers and the like) by hand, vehicle, or airplane consisting of a built-in soft vehicle rack (1) and adjustable built-in vehicle strapping system (3) to safely and securely attach the unit to any type of vehicle; adjustable built-in top straps and multiple board “Buddy System” strapping (2) to attach additional sports board bags to the unit; carrying handle (5) and built-in wheel (8) for either hand carrying or rolling the unit with ease; universal clipping system (14) so that additional BTS: Board Transportation System units may be securely clipped to the main unit; zippers for the main compartment (11) that are compatible for use with padlocks to provide additional security for bag contents; large exterior pocket (10) for storage of sports accessories; and protective padding (12) to ensure the safety of the sports board's transportation. Finally, the unit is covered with a UV-rated material (6) to protect the contents from various weather conditions during storage or transportation.

### CROSS-REFERENCE TO RELATED APPLICATIONS

This application claims benefit of Provisional Patent Application No. 60/364,425, filed Mar. 13, 2002 by the present inventors.

### FEDERALLY SPONSORED RESEARCH

Not Applicable

### SEQUENCE LISTING OR PROGRAM

Not Applicable

### BACKGROUND OF THE INVENTION

A surfboard is made up of fiberglass and foam. It is a very fragile piece of equipment and can be damaged extremely easily. Fiberglass is sensitive to heat and stress. The fins on a surfboard are also very sensitive to stress and can snap with ease. A surfboard can range from 4 to 10 feet long and can be as wide as 22 to 36 inches. Some boards, mainly “Longboards” (8-10 feet in length) can weigh up to 25 pounds. Most “shortboards” (5-7 feet in length) weigh less than 10 pounds.

A surfer has various needs for safekeeping the board during both storage and travel. One product for storage and travel is the “Board bag.” There are many different types of “Board bags.” Traditionally, the make-up of a “Board bag” has been materials like cotton, padded nylon, and hard plastic travel cases. Some bags can be as simple as a cloth material that is pulled over the board to keep it clean. Other bags that are padded, heat resistant, and have carrying provisions (like a handle or a shoulder strap) are very useful in transporting the board and protecting the board from sun damage, heat, or pressure dings. Board bags range in size and material depending on the surfboard size and traveling needs. There are some board bags that have room for multiple boards, various zippers for storing other objects, and have hard covers for traveling by air.

When a surfer is traveling by car, the board can be stored on top of the car using a surfboard rack. There are various types of car racks, but the most common racks for cars are usually either “hard racks” (permanent metal racks) or “soft racks” (portable padded racks). The rack systems work by strapping the board to the padded rack on top of the vehicle with an additional strap.

In the past, all of these needs for storing and transporting a surfboard have been met by acquiring different products: a board bag, a vehicle roof rack system, and strapping to attach the board bag to the vehicle or the roof rack system.

More recently, inventors have created board bags that have attachable strapping systems in order to secure the board bag to the vehicle. U.S. Pat. No. 4,793,535 to Johnson (1988) discloses a board bag that may be used as a back-pack and as a roof rack for transporting a surfboard by vehicle. U.S. Pat. No. 6,230,951 to Anderson (2001) discloses a board “bag for storing, carrying, or holding on top of a vehicle a surfboard, wakeboard, or snowboard that protects stores, displays, and travels all in one comprehensive product;” however, all the board bags heretofore known suffer from a number of disadvantages:

a) Johnson's design utilizes a “special rack-attachment adapter by which the sack carrier may be converted into a rack for mounting to the roof of an automobile”; however, this design is dependent on the vehicle having a “roof gutter” which is not only cumbersome to attach, but, limits the invention's use to older model vehicles that have a roof gutter.

b) Johnson's “special rack-attachment adapter” consists of several independent pieces which must be attached to the unit. This “adapter” is not permanently attached to his design, and, therefore subject to loss.

c) Anderson's invention, similar to Johnson's, also utilizes a strapping system that is not permanently attached to the unit. Since the pieces are independent of the unit, loss of any straps can prevent the unit from being used in the manner for which it was designed.

d) Additionally, Anderson's design straps the bag down in such fashion that it “conforms to the vehicle's roof”. This design creates a serious and large point of contact for both heat, which can damage the board being transported, and wear and tear to the automobile by rubbing on the vehicle's roof paint.

e) Neither Johnson's nor Anderson's design allow for additional board bags to be attached to their respective design without the purchase and use of additional strapping material.

What is needed is an improved board bag, which incorporates in one single unit (without the use of any attachments) a protective board bag, a vehicle transportation rack system, and additional strapping to securely attach multiple board bags together without the need to purchase any other additional equipment or straps. The present invention includes all of the necessary components required to conveniently and safely store or transport any sports board by hand, on airlines, or on a motor vehicle in a single self-contained unit.

### BACKGROUND OF INVENTION—OBJECTS AND ADVANTAGES

Several objects and advantages of the present invention are:

(a) to provide a board bag that will safely and securely strap through the passenger compartment of all passenger cars and SUVs regardless of existing roof design;

(b) to provide a board bag that, in itself, is a transportation unit including a vehicular “soft” roof rack system in one self-contained and permanently attached unit;

(c) to provide a board bag which contains zipper pouches that contain the permanent straps for the tie-down to vehicle;

(d) to provide a board bag which has polyurethane foam, or the like, sewn into the bag to provide separation between the vehicle roof and the bag contents;

(e) to provide a board bag which includes built-in adjustable “buddy” straps (concealed in zipper compartments) to allow for additional board bags to be securely strapped onto the main bag;

### BACKGROUND OF INVENTION—OTHER OBJECTS AND ADVANTAGES

Additional Objects and Advantages of this design are:

(a) to provide a board bag which will utilize a universal clipping system that will allow multiple BTS: Board Transportation System units to be clipped together for hand carry, vehicular or air transportation;

(b) to provide a board bag which will accommodate, depending on the model, one to seven boards within one single unit;

(c) to provide a board bag with a built-in wheel and carrying handle for ease in transport;

(d) to provide a board bag which will have a sewn handle for hand carrying;

(e) to provide a board bag which has protective padding for its contents;

(f) to provide a board bag which will be covered in a UV rated material, or the like;

(g) to provide a board bag which will offer an optional woven steel or like material within the strapping system as a theft-deterrent;

(h) to provide a board bag which will use nylon noncorrosive zippers, or like material, with attachments for easier opening of compartments and locks for security;

(i) to provide a board bag which will offer various pockets sewn into the bag to store sports accessories or personal items;

(j) to provide a board bag in which the contents of the bag may be removed without taking the bag off of the vehicle; and

(k) to provide a board bag which will have coordinating luggage that will easily clip to the board bag using the universal clips.

Further objectives and advantages are to provide a single unit transportation system for all types of board sports: not only for surfboards, but also for snowboards, snow skis, water skis, wake boards, wind surfers, kite surfers and the like. The design of the various units will all be based off of the current invention and only size modifications will be made for each model of board transportation system. Still further objects and advantages will become apparent from a consideration of the ensuing description and drawings.

### SUMMARY

Briefly, and in general, the present invention entitled “BTS: Board Transportation System” is a dual-purpose sports board bag with built-in automotive vehicle roof rack system that incorporates additional product features for both convenience and safety to store or transport surfboards, snowboards, water skis, snow skis, wake boards, wind surfers, kite surfers (and the like) by hand, vehicle or air. The physical structure consists of an insulated bag made of durable UV-rated materials or the like. The base, which will include a built-in vehicle “soft” rack system, will be covered with a non-abrasive fabric or like material. Four adjustable vehicle straps, concealed in zipper pouches, can be used to attach the board bag to any automobile through the passenger's compartment of the vehicle. The main zipper compartment is provided to allow for storage of a single or multiple sports boards. The adjustable top strap & multiple board bag strapping system, also concealed in the zipper compartments on the unit, allow the user to safely strap multiple board bags together for hand carrying, automobile, and airline transportation. The additional product features include, but are not limited to:(a) large exterior pocket for storage of personal items or accessories, (b) a built-in wheel and handle system to allow the bag to be rolled instead of carried, (d) both standard and optional anti-theft devices, and (e) universal clips, a system unique to BTS, that allows additional BTS units to be securely clipped together.

### DRAWINGS—FIGURES

The invention will be more readily understood with reference to the accompanying drawings, wherein:

FIG. 1 shows general bottom view of unit with all features extended out of the unit.

FIG. 2 shows a cross-sectional view—along the midline of the unit.

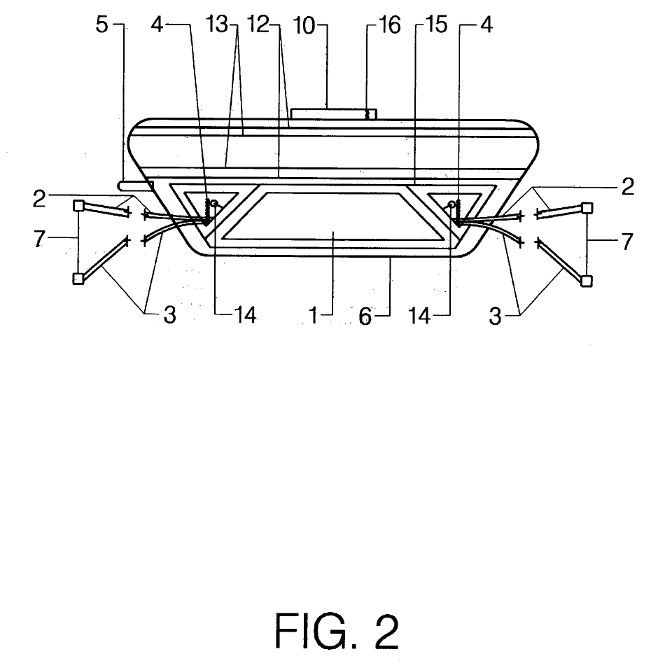

FIG. 3 shows top view of unit with all built-in systems stored inside the unit.

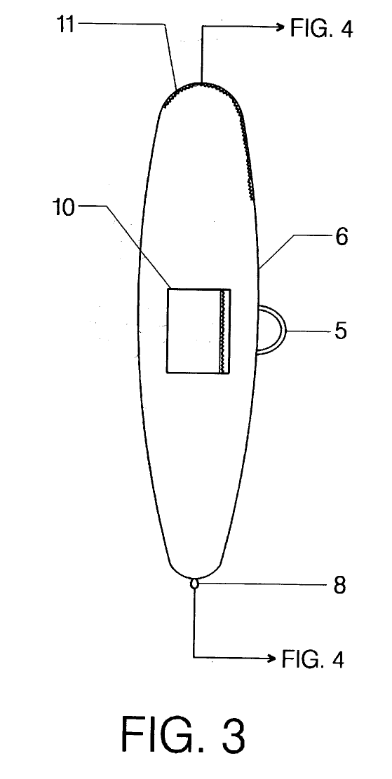

FIG. 4 shows a cross-sectional view—along the length of the unit.

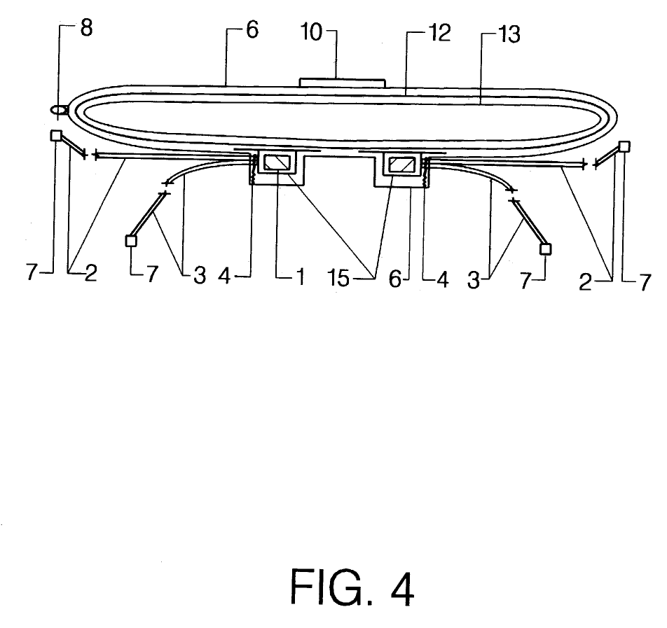

FIG. 5 shows, in 3-D, the unit in operation attached to a vehicle.

### DRAWINGS—REFERENCE NUMERALS

1 built-in “soft rack” padding

2 built-in top strap and multiple board “Buddy System” strapping

3 built-in vehicle strapping system

4 zipper pockets for strapping system storage

5 carrying handle for hand carry

6 exterior cover

7 male/female clips

8 built-in wheel

9 carrying handle for rolling unit

10 external storage pocket

11 zipper opening for board storage

12 protective padding

13 interior lining

14 universal clips

15 fabric backing

16 external storage pocket zipper

### DETAILED DESCRIPTION—PREFERRED EMBODIMENTS

In the following description, which is illustrative only and not limiting, reference numerals will be used to refer to corresponding elements in the different figures of the drawings.

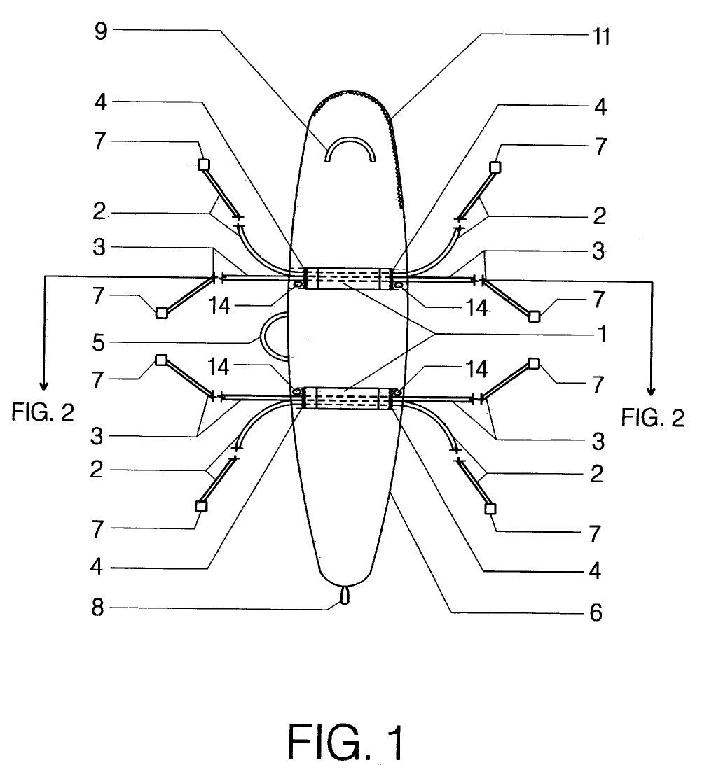

FIG. 1 shows one main embodiment of the BTS: Board Transportation System. The sack or bag for carrying and transporting a variety of sports boards is generally oblong in shape, preferably made of a UV-rated exterior cover (6) with a zipper opening (11) for board storage that is constructed with protective padding (12) and sewn into the unit underneath an interior lining (13). Sewn under the lining are four built-in zipper pockets for strapping system storage(4) (two located on each side of the unit) which contain an adjustable built-in top strap and multiple board “Buddy System” strapping(2); adjustable built-in vehicle strapping system (3); and the universal clipping system (14) which is sewn over the built-in soft rack padding (1) and onto fabric backing (15), and then attached to exterior cover (6). Male/female clips (7) are attached onto the ends of the built-in top straps (2) and vehicle strapping (3). Exterior elements attached to the unit include carrying handle for hand carry (5), built-in wheel (8) with accompanying carrying handle for rolling unit (9), and external storage pocket (10).

Reference numeral 1 is the built-in soft rack padding made of closed cell foam, or like material. Padding (1) is to lift the unit's contents off the vehicle and allow minimal amount of the exterior cover (6) to make contact with the vehicle.

Reference numeral 2, built-in top strap and multiple board “Buddy System” strapping is made of nylon type material, or the like. At the end of each strap is a male or female clip (7). Top strap clips together over the unit to ensure added security in strapping down the bag and contents or to secure an additional board and/or bag on top of the unit.

Reference numeral 3, built-in vehicle strapping system is made of nylon or like materials and has a male or female clip (7) attached at the end of strap. This system is used to attach the unit to a vehicle through the passenger compartment.

Reference numeral 4, zipper pockets for strapping storage, two pockets located on each side of the unit, are a convenient storage unit for built-in top strap and multiple board “Buddy System” strapping (2), built-in vehicle strapping (3) and universal clips (14).

Reference numeral 5, carrying handle, is made of nylon strapping or like material for easy side carrying of the unit.

Reference numeral 6, exterior cover, is made of UV-rated nylon or Dacron like material.

Reference numeral 7, male/female clips, made of plastic or like material, are attached to the ends of the top strap (2) and vehicle straps (3) in order to fasten the ends of each respective strap together. The clips (7) at the end of the top strap (2) secure the unit during transportation or to attach additional boards and/or bags to the main unit. The clips (7) at the end of the built-in vehicle strapping (3) are used to secure the unit to a vehicle through the passenger compartment, by fastening the clips (7) together.

Reference numeral 8, built-in wheel, made of rubber, polyurethane, or the like, is built-in to the front of the unit, and when used with handle(9), the unit can be easily wheeled by hand.

Reference numeral 9, carrying handle for rolling unit, made of nylon strapping or like material, is located on the bottom end of the unit to assist both in lifting and pulling the unit.

Reference numeral 10, external storage pocket, will be made of the same material as exterior cover (6) and will be sewn onto the unit for the storage of sports accessories or personal items.

Reference numeral 11, zipper opening for board storage, is made of nylon, non-corrosive materials, or the like, and the opening is to accommodate the insertion or retrieval of the contents.

Reference numeral 12, protective padding, made of foam material, or the like, is used to protect the contents of the unit from damage.

Reference numeral 13, interior lining, made of lightweight polyester or like material, and is used to protect the contents of the unit.

Reference numeral 14, universal clips, made of plastic, or like material, are similar to the male/female clips (7) and are located in the zipper compartment. The clips can be used to attach and secure another BTS product (with universal clips) to the unit.

Reference numeral 15, fabric backing, made of nylon, Dacron, or like material, is used to secure and surround the built-in systems. Both built-in straps (2 & 3) are sewn onto the fabric backing for added strength and security. The fabric backing is then sewn onto the exterior cover.

Reference Numeral 16, external storage pocket zipper, made of nylon, non-corrosive material or the like is for closure of the external storage pocket.

### DETAILED DESCRIPTION—OPERATION OF INVENTION

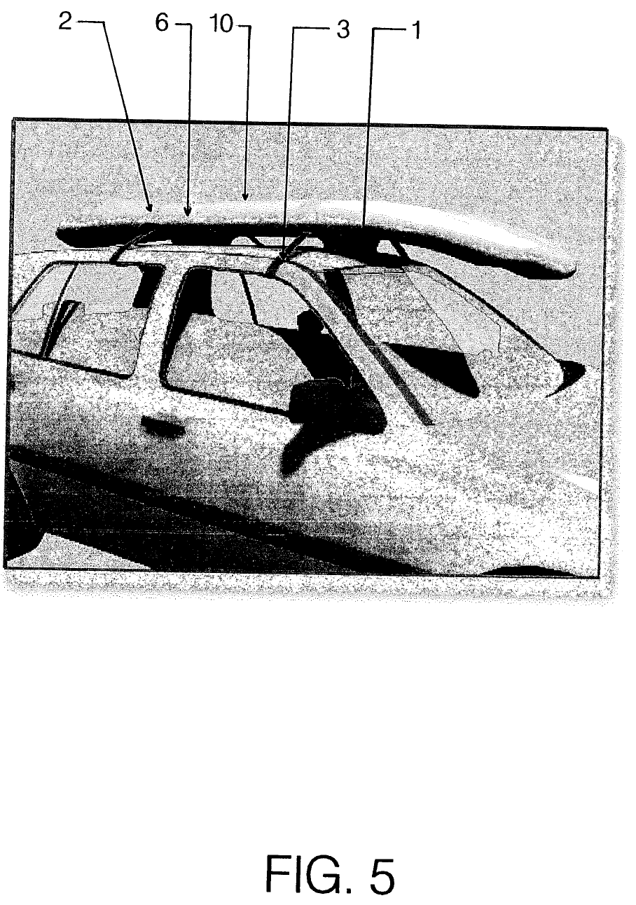

FIG. 5 shows the unit in operation attached to a vehicle. First secure the sports board for storage or transportation; insert the desired board(s) into the BTS: Board Transportation System by opening the zipper opening for board storage (11); insert board(s); and close zipper (11). To strap a BTS: Board Transportation System unit on top of a vehicle, the unit must first be placed, padding side down, on the vehicle's roof. Open the four zipper pockets for strapping system storage (4)(reference FIG. 1); two pockets are located on each side of the unit. Remove one built-in vehicle strapping system (3) from each of the four pockets. Open the passenger and driver's side doors of the vehicle; pull the built-in vehicle straps (3) into the interior of the vehicle; fasten the male/female clips(7)located at the end of said straps, and pull each strap to a firm tension. Remove built-in top strap and multiple board “Buddy System” strapping (2) from each of the four pockets; pull the straps over the top of the unit and fasten the attached male/female clips (7); pull firmly on strap to achieve desired tension. The contents of the BTS: Board Transportation System may be removed from the unit without taking the unit off of the vehicle.

### DETAILED DESCRIPTION—ADDITIONAL EMBODIMENTS

To transport the BTS: Board Transportation System by hand, handle (5) is provided for hand carrying. To roll the unit by hand, built-in wheel (8) is accompanied by carrying handle for rolling unit (9). Simply stand the unit up on it's wheeled end and pull the unit with the handle (9). Said handles (5 & 9) can also be used for lifting the unit by hand.

To attach additional boards and/or bags to the BTS unit for hand carrying, vehicle transportation, or airline transport, simply place the desired additional load on top of the BTS: Board Transportation System; remove one each of the top strap and multiple board “Buddy System” strapping (2) from each of the four zipper pockets for strapping system storage (4); pull said straps over the top of the unit; fasten the male/female clips (7) together, and pull down on the straps to reached the desired tension.

To attach another BTS: Board Transportation System product to the main unit for hand carrying, vehicle transportation, or airline transport, simply place the desired unit(s) on top of the BTS: Board Transportation System; remove the universal clips(14) from each of the four zipper pockets for strapping system storage (4); line up said clips with existing universal clips (14) on the additional load and clip together. Up to three additional units can be clipped to the base unit. All products within the BTS: Board Transportation System line can be connected together regardless of contents (e.g. a snowboard unit can be attached to a surfboard unit, a wakeboard unit can be attached to a surfboard unit, two units of the same contents can be attached together, etc.).

### DETAILED DESCRIPTION—ALTERNATIVE EMBODIMENTS

A BTS: Board Transportation System can also be suspended in the open bed of a pick-up truck by utilizing the truck's existing tie-down system (e.g. eye bolts, c-clips, d-rings, or void areas); place the unit in the bed of the truck, and remove the four built-in vehicle strapping system (3) from each of the four zipper pockets for strapping system storage (4); loop each said strap through or around the truck's existing tie-down system; connect the male/female clips (7), and pull firmly on said straps until the desired tension is achieved. This form of vehicle transportation limits the unit's and it's contents contact with the tailgate of the truck and allows for additional storage space within the bed of the truck. Additional boards and/or bags can be attached to the suspended unit by utilizing the built-in top strap and multiple board “Buddy System” strapping (3), or, alternately, additional BTS units can be safely and securely attached to the suspended unit by utilizing the four built-in universal clips (14) located in each of the four zipper pockets for strapping system storage (4).

Alternately, a BTS: Board Transportation System can be mounted on all types of lumber racks found on most mini, mid-size, and full-size pick-up trucks. To mount the unit in this fashion, place the BTS: Board Transportation System on top of the existing lumber rack; remove the four built-in vehicle straps (3) from each of the four zipper pockets for strapping system storage (4); loop each strap around a desired area of the lumber rack and fasten the male/female clips (7) and firmly pull on said strap to reach the desired tension. Additional boards and/or bags can be attached to the unit by utilizing the built-in top strap and multiple board “Buddy System” strapping (3), or, alternately, additional BTS units can be safely and securely attached to the unit by utilizing the four built-in universal clips (14) located in each of the four zipper pockets for strapping system storage (4).

### Advantages

From the description above, the main advantage of the present invention is that any sports board can be safely stored or transported by hand, vehicle, or air without the purchase of, or need to attach, any additional equipment. The built-in nature of the design makes this portable unit convenient, easy to use, and secure. Additional advantages of the BTS: Board Transportation System also become evident:

(a) The BTS: Board Transportation System can safely and securely strap through the passenger compartment of all passenger cars and SUVs regardless of existing roof design;

(b) The unit includes a built-in vehicular “soft” roof rack system in one self-contained and permanently attached unit to provide separation between the vehicle roof and the bag contents;

(c) The zipper pouches that contain the built-in systems provides a convenient way to use the BTS: Board Transportation System for hand carrying, vehicular or airline transportation;

(d) The built-in adjustable top strap and multiple board “Buddy System” straps (concealed in zipper compartments) allow for additional board bags to be securely strapped onto the main bag;

(e) The universal clipping system allows multiple BTS: Board Transportation System units to be clipped together for hand, vehicular or air transportation;

(f) The design of the BTS: Board Transportation System will accommodate, depending on the model, one to seven boards within one single unit;

(g) The BTS: Board Transportation System includes a built-in wheel and carrying handle for ease in hand transport and sewn handle for hand carrying and/or lifting;

(h) The BTS: Board Transportation System has nylon (or like material) non-corrosive zippers with attachments for easier opening of compartments and locks for security;

(i) The contents of the BTS: Board Transportation System may be removed without taking the bag off of the vehicle.

### Cnclusion, Ramifications, and Scope

Accordingly, the reader will see that this invention, the BTS: Board Transportation System, is, in fact, a self-contained transportation unit, and it can be used to safely and securely store and transport any sports board by hand, vehicle, or by air without the need of attachments or additional equipment. The built-in systems allows the user to modify the bag to their individual and immediate needs. BTS can be used as a safe storage container, or it can be used to hand carry a variety of sports boards and accessories with great ease. Then, when required, the unit can be safely and securely attached to any vehicle through the passenger compartment for vehicular transportation. Additionally, the interior padding allows for safe and secure airline transportation of any sports board while accommodating the fragile nature of the enclosed equipment. Furthermore, the BTS: Board Transportation System has the additional advantages in that

the built-in top strap and multiple board “Buddy System” strapping allows for additional board bags to be safely and securely attached to the main unit for storage or transport;

it provides a polyurethane foam, or the like, “soft rack” sewn into the bag that provides separation between the vehicle roof and bag contents when the unit is used for vehicular transportation;

it provides a built-in universal clipping system that allows additional BTS units (or BTS luggage) to be safely and securely clipped to the main unit;

it provides theft-deterrent items such as zippers that accommodate pad locks and optional woven steel or like material within the strapping systems to prevent the unit from being cut off of a vehicle;

it provides a board bag in which the contents can be removed and the bag can continue to safely be stored on the vehicle;

it provides a board bag that offers a large exterior pocket to store sport accessories or personal items;

it provides a board bag that is covered in a UV rated or like material to provide additional protection of the contents;

it provides a board bag that utilizes non-corrosive zippers with attachments for easy opening;

it provides a board bag which will have coordinating luggage designed that will easily clip to the unit using the built-in universal clips;

it provides for hand carrying with both a handle and built-in wheel and hand strap for rolling the unit; and

it provides a board bag that will safely accommodate multiple boards in one bag.

Although the above description contains many specifics, these should not be construed as limiting the scope of the invention, but as merely providing illustrations of some of the presently preferred embodiments of this invention. The scope of the invention should be determined by the appended claims and their legal equivalents, rather than by the examples given.

We claim:

1. A container for storing, carrying, and transporting any sports board such as a surfboard, snowboard, wakeboard, snow skis, water skis, kite surfer, and the like comprising:
a. a built-in “soft rack” padding;
b. a built-in adjustable vehicle strapping system;
c. a built-in adjustable top strap and multiple board strapping system;
d. a zipper opening for contents;
e. a large exterior storage pocket;
f. a built-in wheel;
g. a handle for hand carrying;
h. a handle for rolling the unit;
i. zipper pouches for built-in straps and clips; and
j. protective padding for container contents.

2. A container as in claim 1 that can be secured onto a vehicle wherein two vehicle straps are connected through the passenger compartment of a vehicle thereby allowing the container to be securely strapped down to the vehicle roof.

3. A container as in claim 1 with adjustable built-in straps thereby allowing additional containers to be securely attached to the main unit.

4. A container as in claim 1 with built-in universal clips thereby allowing additional BTS containers to be securely clipped to the main unit.

5. A container as in claim 1 wherein the “soft rack” padding is comprised of polyurethane closed-cell foam, or the like.

6. A container as in claim 1 wherein the zippers shall be made of a nylon (or nylon-like material) that is non-corrosive.

7. A container as in claim 1 that will accommodate as few as one and as many as seven boards.
